(19) United States
(12) Patent Application Publication
(10) Pub. No.: US 2014/0333291 A1
(43) Pub. Date: Nov. 13, 2014

(54) METHOD AND APPARATUS FOR IDENTIFYING LOCATIONS OF SOLAR PANELS

(71) Applicant: HIQ SOLAR, INC., Santa Clara, CA (US)

(72) Inventors: Andre P. WILLIS, PALO ALTO, CA (US); Clinton A. FINCHER, SUNNYVALE, CA (US); Guy M. FOSTER, WINDSOR, CA (US)

(73) Assignee: HIQ SOLAR, INC., Santa Clara, CA (US)

(21) Appl. No.: 14/208,097

(22) Filed: Mar. 13, 2014

Related U.S. Application Data
(60) Provisional application No. 61/820,483, filed on May 7, 2013.

(51) Int. Cl. G01B 7/00; G01B 11/14

(52) U.S. Cl. CPC G01B 7/003; G01B 11/14
USPC 324/126; 356/614; 356/51

(57) ABSTRACT

System and method for identifying solar panels. In accordance with exemplary embodiments, an electrical signal within one or more solar cells of the solar panel is detected and processed to provide a detection signal corresponding to a distinguishing characteristic associated with the solar panel. In accordance with alternative exemplary embodiments, a light sensor is disposed along a sightline from the solar panel to detect a light emission produced by dissipation of electrical power by one or more solar cells of the solar panel. In accordance with further alternative exemplary embodiments, selective blocking of light to (e.g., shading of) portions of predetermined solar panels causes corresponding changes in output power that can be used to identify affected solar panels.

### RELATED APPLICATIONS

This application claims priority to and the benefit of U.S. Patent Application 61/820,483, entitled “Method and Apparatus for Identifying Location of Solar Panels,” which was filed on May 7, 2013, the disclosure of which is incorporated herein by reference.

### BACKGROUND

The present invention relates to solar panel arrays, and in particular, to techniques for remotely identifying individual solar panels within such arrays.

Following construction of a solar installation it is common to record the physical locations and electrical connections of solar panels in order to later identify performance issues and aid maintenance, replacement, etc. The process of recording locations is labor-intensive, time-consuming and prone to error.

Solar panels have two connection wires that carry power generated from solar radiation. These wires are connected either in series with other panels, or directly, to a load or termination device such as an inverter.

### SUMMARY

In accordance with the presently claimed invention, a system and method are provided for identifying solar panels. In accordance with exemplary embodiments, an electrical signal within one or more solar cells of the solar panel is detected and processed to provide a detection signal corresponding to a distinguishing characteristic associated with the solar panel. In accordance with alternative exemplary embodiments, a light sensor is disposed along a sightline from the solar panel to detect a light emission produced by dissipation of electrical power by one or more solar cells of the solar panel.

In accordance with one embodiment of the presently claimed invention, a system for identifying a solar panel associated with a distinguishing characteristic includes: a first conductor for coupling to one or more solar cells of the solar panel; a second conductor for coupling to a conductive element of the solar panel; and detection circuitry coupled to the first and second conductors and responsive to an electrical signal in at least one of the first and second conductors by providing a detection signal corresponding to the distinguishing characteristic.

In accordance with another embodiment of the presently claimed invention, a method for identifying a solar panel associated with a distinguishing characteristic includes: coupling a first conductor to one or more solar cells of the solar panel; coupling a second conductor to a conductive element of the solar panel; and responding to an electrical signal in at least one of the first and second conductors by providing a detection signal corresponding to the distinguishing characteristic.

In accordance with another embodiment of the presently claimed invention, a system for identifying a solar panel includes: one or more conductors coupled to one or more solar cells of the solar panel to convey electrical power from an external power source to at least one of the one or more solar cells, wherein dissipation of the electrical power by the at least one of the one or more solar cells produces a light emission; and a light sensor disposed along a sightline such that the light emission is visible to the light sensor.

In accordance with another embodiment of the presently claimed invention, a method for identifying a solar panel includes: coupling one or more conductors to one or more solar cells of the solar panel to convey electrical power from an external power source to at least one of the one or more solar cells, wherein dissipation of the electrical power by the at least one of the one or more solar cells produces a light emission; and disposing a light sensor along a sightline such that the light emission is visible to the light sensor.

### BRIEF DESCRIPTION OF THE DRAWINGS

FIG. 1 depicts how physical changes in an individual solar panel may be used to identify its physical location in accordance with exemplary embodiments of the presently claimed invention.

FIG. 2 depicts solar panels connected to a load-balancing device.

FIG. 3 depicts a method of panel detection in accordance with exemplary embodiments of the presently claimed invention.

FIG. 4 depicts an alternate implementation of panel detection using a smartphone with undercarriage in accordance with exemplary embodiments of the presently claimed invention.

FIG. 5 depicts inducing periodic shading in a single panel to allow detection in accordance with exemplary embodiments of the presently claimed invention.

FIG. 6 depicts a device for periodically modulating shade of a solar panel.

FIG. 7 depicts anchoring a location of one panel and relative positioning of neighboring panels.

FIG. 8 depicts use of a camera to map panel locations using a Method 1 device in accordance with exemplary embodiments of the presently claimed invention.

FIG. 9 depicts a method for using a camera to photographically record panel location in accordance with exemplary embodiments of the presently claimed invention.

FIG. 10(a) depicts a logical layout of solar panels.

FIG. 10(b) depicts a physical layout of solar panels on a roof.

### DETAILED DESCRIPTION

As discussed in more detail below, exemplary embodiments of the presently claimed invention enable: identification of a solar panel amongst many by modulating voltage and current of the termination device to which it is attached and detecting the consequent changes in a panel's electromagnetic and/or light emission and/or current and/or temperature using a sensor; mapping the physical location of a panel to its logical position in systems which provide per-panel monitoring, through correlation of sensor data with positional and/or photographic information; and modulating of shading of a solar panel using a device and then identifying its location by detecting modulation of power it produces using the device to which it is terminated.

### Method 1—Identification Using Electrical Modulation

A typical function of a load device is to vary its characteristics to maximize power harvest from a solar panel (commonly called Maximum Power Point Tracking, or MPPT). This can be applied to a string of panels, or to panels individually. The method described applies to systems where panels are optimized individually. By varying the load characteristics or in other ways it is possible to modulate the voltage and current of the panel. (Further discussion of this can be found in U.S. Patent Application 61/781,522, entitled “Reverse Energy Flow In Solar and Other Power Generation Systems For Theft Detection, Panel Identification and Diagnostic Purposes”, which was filed on Mar. 14, 2013, the disclosure of which is incorporated herein by reference.) This electrical modulation will cause:

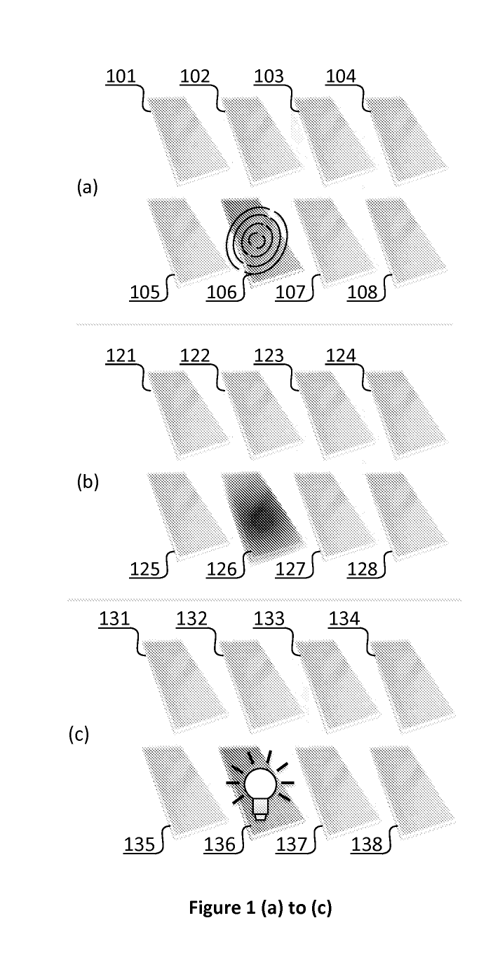

v) Light emission by the solar cells in the panel (FIG. 1(c) (136)) when supplied with current may be detected with an infrared detector/camera
w) Electromagnetic field changes near the surface of the panel (FIG. 1(a) (106)) which may be detected with an external device (discussed in more detail below)
x) Thermal effects in the panel (FIG. 1(b) (126)) which may be detected by a thermal camera or similar device
y) Current changes in the panel wires which may be detected using a current clamp or similar device

By making the modulation to each panel unique it is possible to identify one panel amongst many.

### Method 1

Modulation

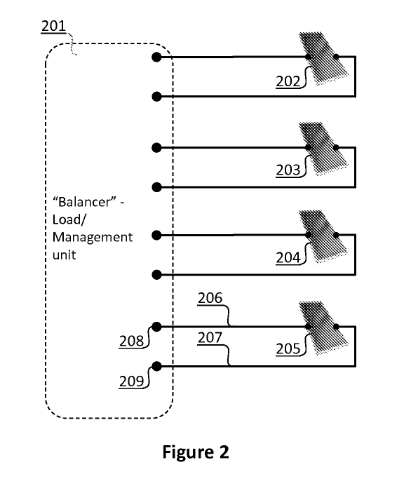

In the preferred implementation solar panels are connected individually to a load-balancing device (see FIG. 2). Panels (202-205) have two wires each (for example (206, 207)) and connect to the load (201). By varying the load rapidly or in other ways altering the panel voltage it is possible to cause detectable changes that allow identification of one panel amongst many. For an architecture using a Balancer such as FIG. 2, it is then possible to modulate one panel at a time, or to modulate all panels but to have different modulation characteristics on each panel. (An example of such a Balancer circuit is described in U.S. Patent Publication 2010/0308660, the contents of which are incorporated herein by reference, and forms of control for such a Balancer circuit are described in U.S. Patent Application 61/781,544, which was filed on Mar. 14, 2013, the contents of which are incorporated herein by reference.) In these ways it is possible to impose a unique signature to an individual panel.

Detection

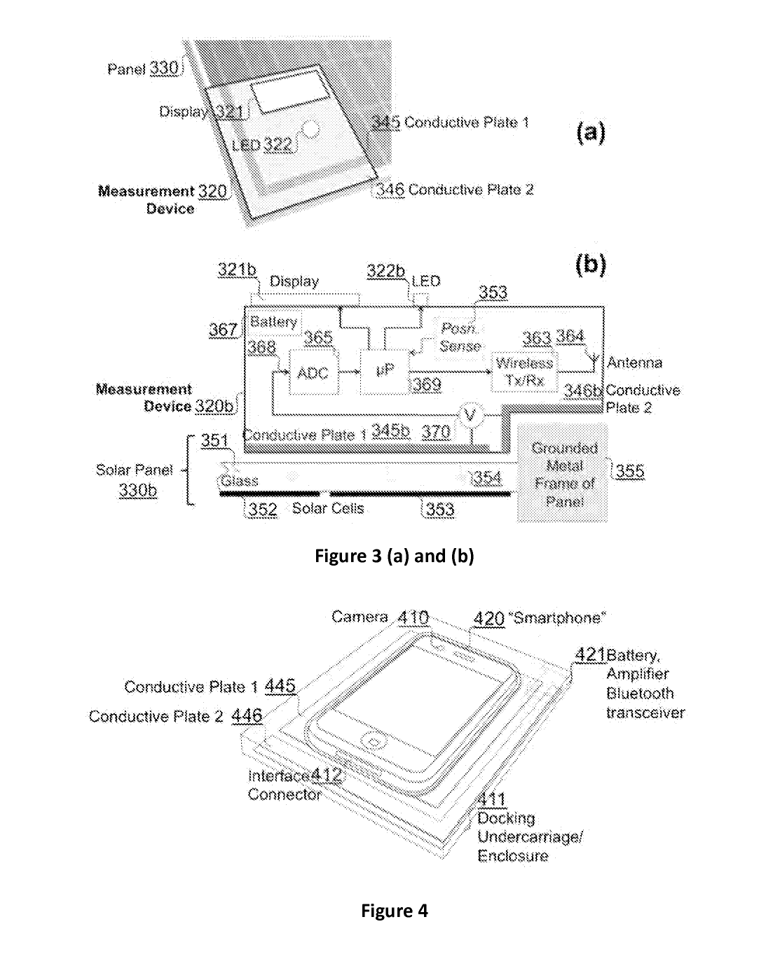

Modulation of the panel electric field (Method 1w) can be detected using a preferred implementation described here, FIG. 3. FIG. 3(a) shows the measurement device (320) in use, placed on a solar panel (330), while (b) shows the same device (320b) in block diagram form placed on the panel (330b).

The preferred implementation senses voltage difference between two conductive plates. The voltage difference is measured using conductive plate 1 (345, 345b), conductive plate 2 (346, 346b) and a voltage measuring transducer (370). The voltage measuring transducer output (368) connects to the input of an ADC (365). The digital output of the ADC connects to a microprocessor (369). The microprocessor (369) drives an indicator LED (322, 342) and a display (321, 321b). It also drives a wireless transceiver (363). The wireless transceiver drives an antenna (364).

The measurement device (320, 320b) is placed on the edge or in the corner of a solar panel so that conductive plate 2 (346b) either electrically connects, or capacitively couples, to the grounded metal frame of the panel (330b). Conductive plate 1 (345b) capacitively (354) couples through the solar panel glass surface, to the solar cells underneath. The coupling detects rapidly changing electric field when the solar cell voltage is modulated. Signal processing capability within the microprocessor (369) will detect the presence or absence of modulation, or recognize a particular modulation signature, and display results using the LED (322, 322b) and/or display (321, 321b). Optionally, the measurement device will contain position-sensing capability (353) including GPS, gyroscopes, accelerometers that connect to the microprocessor (369).

Optionally the conductive plates (345, 346) might be configured in other shapes, for example Conductive plate 2 (346) might be shaped to fit all of the way around the perimeter of the base of the device, with Conductive plate 1 (345) enclosed by it, so that the device can connect to the panel frame (355) in a variety of orientations.

An alternative implementation of the measurement device is shown in FIG. 4 using a smartphone (420) with an undercarriage (411) that protects the phone, provides connection to, and houses, the conductive plates (445, 446). Connection can be achieved using the interface connector (412), the headphone/microphone jack (not shown) or via Bluetooth (421). The smartphone contains most of the elements of FIG. 3(b), including the Microprocessor (369), display (321b), position sensors (353), battery (367), wireless transceiver (363) and antenna (364) as well as a camera (410). If it does not contain suitable voltage transducer (370), amplifier and power source (421) and ADC inputs (365), these will be contained in the undercarriage (411).

Infrared light emission from the panel (Method 1v) may be detected using an infrared-sensitive camera. It is also detectable using a preferred implementation based on FIG. 3. The Conductive Plates 1 & 2 (345b, 346b) are replaced with an infrared-sensitive photodetector mounted in a hole in the enclosure with the detector's sensitive face directed towards the panel glass (351). This implementation provides short-range detection, an infrared-sensitive camera would provide detection capability over a longer distance.

Infrared light emission based on the architecture of FIG. 2 and detection using the preferred implementation of FIG. 3 with photo-detector modification as described above enables a communication link to be created. Modulation of the current through the panel will cause the infrared output to be modulated. Digital modulation of kilobits/second or greater is possible. This allows data such as the panel identity and other system data to be communicated to the detection device. When the solar panel is in direct sunlight, if the detector does not completely cover the section of panel, stray light will reduce the signal-to-noise ratio at the receiver. In such a case, a synchronous detection scheme will improve reliability of demodulation.

Temperature changes in the panel (Method 1x) induced using Method 1 are detectable using a thermal camera to pick out a panel that is being modulated among a group of many where the others are not being modulated.

Changes in current in the panel (Method 1y) induced using Method 1 wires are detectable using a current clamp.

### Method 2—Identification Using Modulated Shading

It is possible to alter the amount of light falling on the panel and detect changes in energy delivered by the panel.

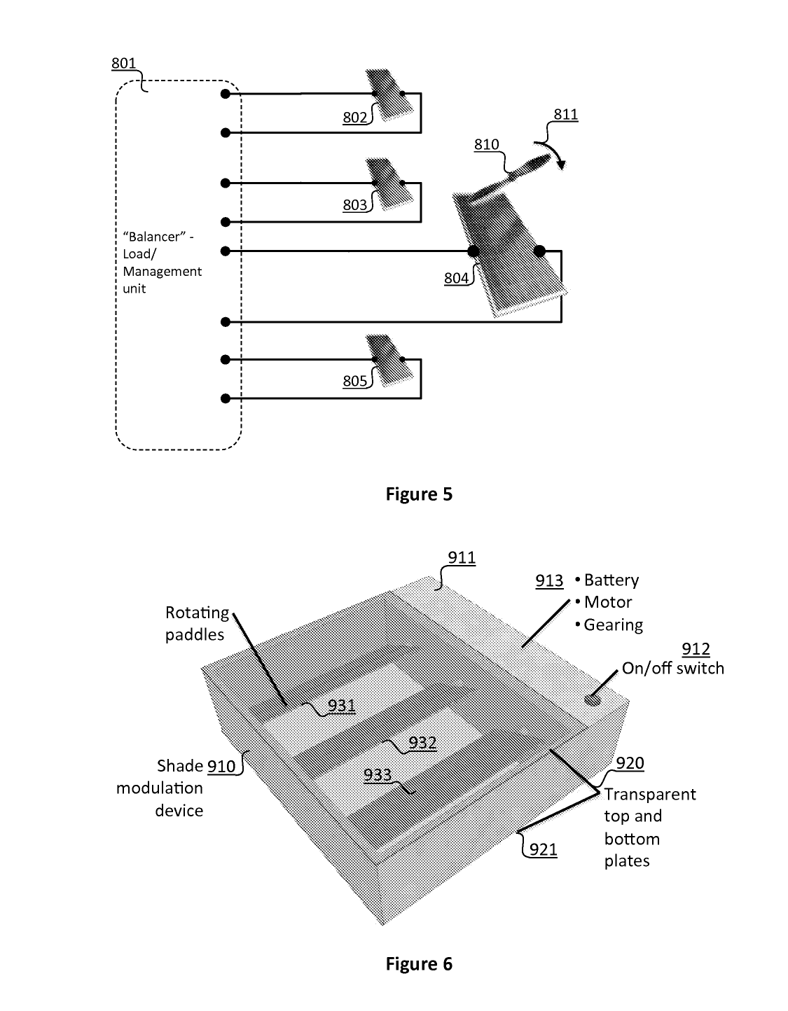

For the architecture identified in FIG. 2, individual connections to each panel allow detection of changes in panel electrical output. In the implementation of FIG. 5, one of the panels (804) of the group (802-805) is shaded by a portable device that has a rotating arm or blade. This provides periodic shading of the panel and cause monitoring of the panel in the load-balancing device (801) to detect changes in that panel uniquely, relative to others in the group. This allows mapping of the physical location of a panel to its logical position in systems which provide per-panel monitoring.

A preferred implementation (910) is shown in FIG. 6. An enclosure (911) is designed to cover a fraction of the area of a single panel, in the range of, but not limited to, ⅛ to ¼. The enclosure (911) contains paddles (931, 932, 933) that rotate, and during rotation are capable of providing significant shade through to insignificant shade depending upon position. The paddles are protected above and below by transparent plates (920, 921). The paddles are caused to rotate by a motor (913) powered by a battery and connected to the paddle shafts by gearing or a drive belt. The motor is controlled by an on/off switch (912).

An alternative implementation of the device shown in FIG. 6 would replace the mechanical rotating paddles (931-933), battery, motor and gearing (913) and top and bottom plates (920, 921) with an LCD panel and electrical circuitry to modulate the amount of radiation received by the panel.

Modulation should not necessarily be periodic. A single pulse of shading or light could provide enough detectable change to allow reliable identification of an individual panel or cluster of panels. If the detection device receives additional information about timing it will improve signal to noise and therefore reliability of detection.

### Method 3—Mapping Panel Locations

Having detected an individual panel using Method 1 or 2, a further step is to map the physical location of a panel to its logical position in systems which provide per-panel or per-group monitoring, through correlation of sensor data with positional data. It is useful to also be able to identify, through a process of elimination, panels that are part of large groups and have accidentally not been electrically connected and are therefore not producing useful energy.

Method 3a—Mapping Panel Positions Using Relative Location

Using a device with capabilities similar to those detailed in FIG. 3 and/or FIG. 4 the identity of a panel in the system can be ascertained. For a device detailed in FIG. 3 positional sensors (353) will include GPS sensors, accelerometers, compass and gyroscopes. A smartphone-based device such as FIG. 4 will also have cellular and Wi-Fi transceivers that can be used to enhance deduction of geographic location. Taken together the devices of FIG. 3, FIG. 4 are capable of absolute knowledge of geographic location, and with greater accuracy also relative movement and tilt. An alternative implementation would use triangulation methods relying on three or more transmitters strategically placed on the perimeter of the installation.

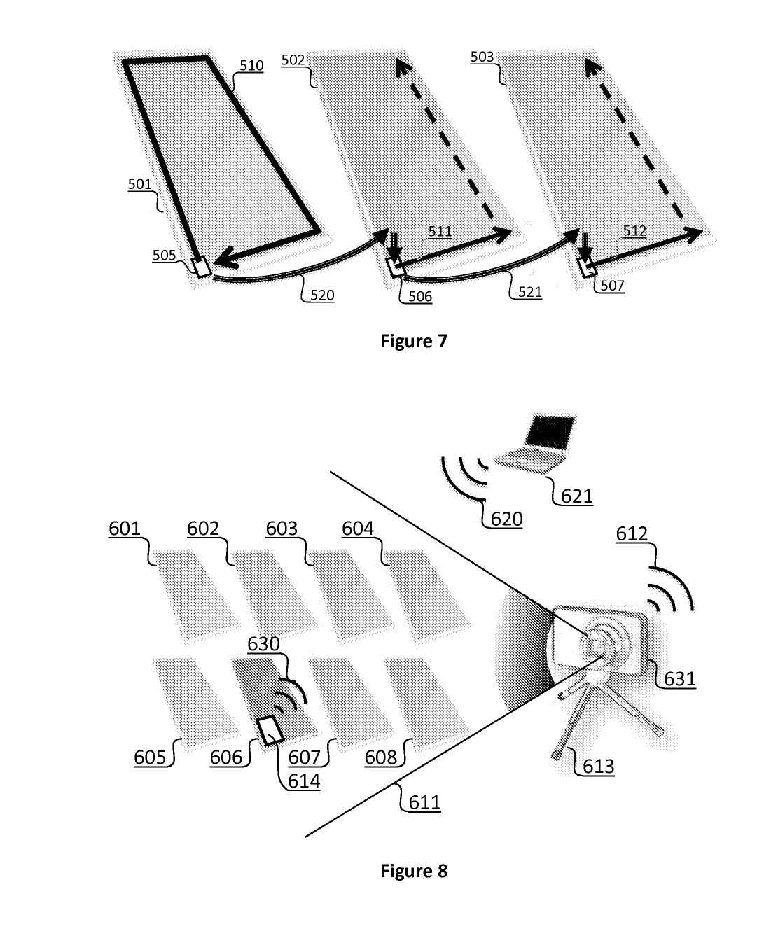

Method 3a, shown in FIG. 7, uses a process of identifying the first panel (501) in a group (501, 502, 503) using the device (505), then moving or swiping the device (505) around the perimeter of the panel (510). This action, when tracked by the positional sensors (353) provides information to the microprocessor (369) on the size and position of the solar panel.

Most solar panel installations use panels in groups of similar physical sizes. Having established the size of the panels in the group (510), it is then only necessary to identify other panels with the same device (506, 507) and then swipe along one or two sides (511, 512) to provide the microprocessor (369) with information to calculate the panel positions relative to the first one in the group. In this way panel identifications will be mapped to physical locations. The device (505) is moved (520) in one motion to the corner (506) of the next panel (502). In addition the device is equipped to measure tilt of each panel.

Using the first panel (501) location as the reference point, measurement of relative movement will decrease in accuracy as the number of movements and the distance from the reference point increases. The device (505) calculates the measurement accuracy tolerance of each measured location point. When a threshold of accumulated error is exceeded, the user is notified through the device user-interface to return to the reference location (501). The device may detect that it has returned to the reference positional, alternatively the user presses a button on the user interface to instruct the device that it is back at the reference location. The user can then return to the location where recording of panel locations had been interrupted and can resume mapping with acceptable accuracy.

Method 3b—Mapping Panel Positions Using Photographs

A preferred implementation is shown in FIG. 8. A camera (631), optionally on a tripod (613), is wirelessly (612) connected to a computer system with mapping software (621), and is positioned so that the camera field of view (611) encompasses some or all of the array of solar panels ((601 to 608) in this example). The detection device of Method 1 (614) communicates wirelessly (630) with the computer (621). The detection device (614) has a user-operable button; when the panel is identified with the detector, the users activates the button which notifies the computer (621) software, and this initiates a photograph to be taken by the camera (631) to record the location of the panels and allow correlation in software of the location of the device (614). An alternative implementation would not require a user to activate a button but will recognize cessation of the sweeping motion and indicate recognition with an audible beep.

The camera (631) may also include a GPS capability that will also provide geographic input data to the software that will calculate locations.

An alternative implementation would eliminate the computer and have the functionality incorporated in the measurement device (614) to control the camera (631) wirelessly (630, 612) and host the required software.

The measurement device (614) has an LED indicator (322, 322b), which illuminates when a panel is successfully identified. An enhancement to Method 3b is to have the measurement device equipped with a two-color LED (322, 322b); the microprocessor (369) in this instance can cause the LED to shine one color, red for example initially, and instruct the camera to take a photograph that will contain the measurement device (614) with the LED (322, 322b) illuminated red. It can then cause the LED (322, 322b) to be illuminated a different color, for example blue. The microprocessor (614) instructs the camera to take a second photograph. The two photographs will be identical except for the color of the LED in each. When the photographs are later processed to identify the physical location of the device (614), calculation will be faster and more reliable because it is quicker to search for the presence of red pixels, then search for the presence of blue pixels in the same location, rather than more complex image recognition.

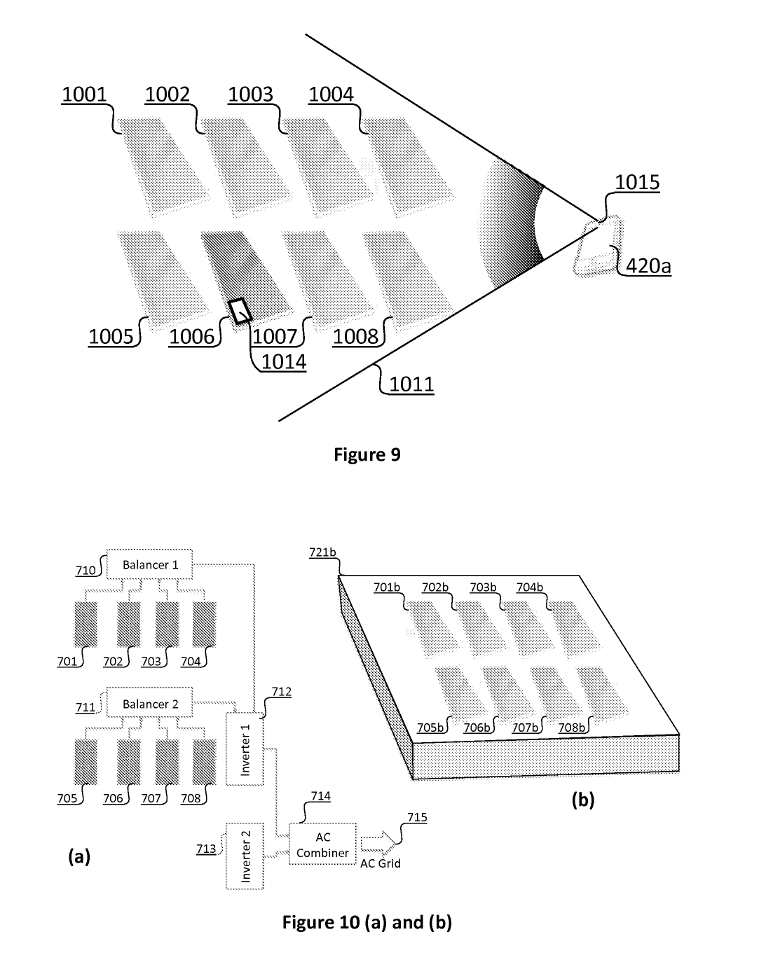

For an implementation similar to FIG. 4 using a smartphone (420, 420a) or similarly equipped device, an alternative approach is shown in FIG. 9. This approach allows the measurement device to identify the panel as illustrated in FIG. 7, and then for the same device to be used to take a photograph to record the panel's physical location. Here a device (1014) such as a brightly colored-square of plastic is used to mark the panel that has been identified, allowing it to be visibly recorded in a photograph.

The panel is identified using the measurement device (420a), and then the plastic marker (1014) is placed on the panel. The user then walks to a suitable location with the panel array in view and takes a picture of the array including the plastic marker using the built in camera (1015). The positioning sensors (GPS, compass, accelerometers, gyroscopes) inside the smartphone (420a) will also be used to track position of the camera to identify the physical location from which the photo is being taken. Optionally, separate photos of the marker (1014) and panel array (1001-1008) may be taken from different locations; this will aid building a detailed picture of the solar array later (Method 3c).

Further to the smartphone (420a) implementation: solar panels usually have barcode labels representing individual serial numbers. As part of the process of panel identification a valuable enhancement is to use the smartphone camera (1015) to scan the serial number of the panel so that the software can associate this with the logical and physical location information.

If the original barcode is not accessible after installation, prior to final positioning of the panel a second unique identifying barcode label may be attached to the panel in a visible location. Taking photographs of both barcode labels at this time allows association of the two labels together. When later panel location work is performed, scanning of the new label is possible even though scanning of the original is not, and in this way the panel will be identified.

Method 3c—Presentation of Panel Locations

The process of identifying and mapping panels allows a detailed model to be built of a particular installation. FIG. 10 shows two different views of the same installation. FIG. 10(a) shows the logical topology with panels (701-708) connected to two different Balancer/combiners (710, 711). These Balancers are connected to an inverter (712) which is connected to an AC combiner box (714) along with another similar inverter (713). The AC combiner box (714) connects to the AC grid (715). An alternative view of the same panels (701-708) is shown in FIG. 10 (b), where the panels are represented as (701b-708b). This view shows the panels with their physical location on the roof (721b).

Having used the methods described earlier there is now sufficient information to correlate logical and physical location information and to present it using software to a user. The logical topology view (FIG. 10(a)) will be straightforward to graphically present as tables, schematics or hierarchical trees of objects. There are several alternatives for creating the physical view (FIG. 10(b)). Single or multiple photographs showing alternative views of the panels on the roof may be accessible when requested. The photographs and positional data may also be used to construct a 3-dimensional wire frame model in software that can also be rendered and used to change viewing perspective as instructed by a user. By pointing and clicking on a particular panel icon or panel picture in either the logical or physical views it will be possible to switch between views, bring up graphs or other representations of panel performance, properties and other system data.

Method 3d—Location-Based Information Availability

Having a correlated view of logical layout and physical layout can be used by an installer or maintenance person while on-site. Panels are usually equipped with serial number labels. Inverters and other system components may be similarly equipped with bar-codes or QR code labels. Scanning of component identifying marks, or tracking of movement using the positioning equipment in a user's smartphone will be used to tie user-location with system component information. The user may then display real-time performance statistics and other system information relevant to their physical location. Such views may be displayed in an augmented reality manner using suitable virtual reality glasses etc.

Various other modifications and alternations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus including a system for identifying a solar panel associated with a distinguishing characteristic, comprising:
a first conductor for coupling to one or more solar cells of said solar panel;
a second conductor for coupling to a conductive element of said solar panel; and
detection circuitry coupled to said first and second conductors and responsive to an electrical signal in at least one of said first and second conductors by providing a detection signal corresponding to said distinguishing characteristic.

2. The apparatus of claim 1, wherein said first conductor comprises a conductive plate for capacitively coupling to said one or more solar cells via a glass surface of said solar panel.

3. The apparatus of claim 1, wherein said second conductor comprises a conductive plate for contacting a metal frame of said solar panel.

4. The apparatus of claim 1, wherein:
said electrical signal comprises a modulated voltage between said first and second conductors; and
said detection circuitry is responsive to said modulated voltage by providing a detected modulation signal.

5. The apparatus of claim 1, wherein:
said electrical signal comprises a modulated current flowing in said first conductor; and
said detection circuitry is responsive to said modulated current by providing a detected modulation signal.

6. The apparatus of claim 1, wherein:
said electrical signal comprises a voltage between said first and second conductors; and
said detection circuitry comprises
a voltage transducer coupled to said first and second conductors and responsive to said voltage by providing a transducer signal related to said voltage, and
processing circuitry coupled to said voltage transducer and responsive to said transducer signal by providing said detection signal.

7. The apparatus of claim 1, wherein:
said electrical signal comprises a current flowing in said first conductor; and
said detection circuitry comprises
a current transducer coupled to said first conductor and responsive to said current by providing a transducer signal related to said current, and
processing circuitry coupled to said current transducer and responsive to said transducer signal by providing said detection signal.

8. The apparatus of claim 1, further comprising a load circuit coupled to said first conductor, wherein said load circuit has a load characteristic associated therewith, and said detection signal is indicative of a modulation of said load characteristic.

9. A method for identifying a solar panel associated with a distinguishing characteristic, comprising:
coupling a first conductor to one or more solar cells of said solar panel;
coupling a second conductor to a conductive element of said solar panel; and
responding to an electrical signal in at least one of said first and second conductors by providing a detection signal corresponding to said distinguishing characteristic.

10. The method of claim 9, wherein said coupling a first conductor to one or more solar cells of said solar panel comprises capacitively coupling a conductive plate to said one or more solar cells via a glass surface of said solar panel.

11. The method of claim 9, wherein said coupling a second conductor to a conductive element of said solar panel comprises connecting a conductive plate to a metal frame of said solar panel.

12. The method of claim 9, wherein:
said electrical signal comprises a modulated voltage between said first and second conductors; and
said responding to an electrical signal in at least one of said first and second conductors by providing a detection signal corresponding to said distinguishing characteristic comprises responding to said modulated voltage by providing a detected modulation signal.

13. The method of claim 9, wherein:
said electrical signal comprises a modulated current flowing in said first conductor; and
said responding to an electrical signal in at least one of said first and second conductors by providing a detection signal corresponding to said distinguishing characteristic comprises responding to said modulated current by providing a detected modulation signal.

14. The method of claim 9, wherein:
said electrical signal comprises a voltage between said first and second conductors; and
said responding to an electrical signal in at least one of said first and second conductors by providing a detection signal corresponding to said distinguishing characteristic comprises
responding to said voltage by providing a transducer signal related to said voltage, and
processing said transducer signal to provide said detection signal.

15. The method of claim 9, wherein:
said electrical signal comprises a current flowing in said first conductor; and
said responding to an electrical signal in at least one of said first and second conductors by providing a detection signal corresponding to said distinguishing characteristic comprises
responding to said current by providing a transducer signal related to said current, and
processing said transducer signal to provide said detection signal.

16. The method of claim 9, further comprising providing a load circuit coupled to said first conductor, wherein said load circuit has a load characteristic associated therewith, and said detection signal is indicative of a modulation of said load characteristic.

17. An apparatus including a system for identifying a solar panel, comprising:
one or more conductors coupled to a solar panel assembly to convey electrical power from an external power source to said solar panel assembly, wherein conduction of said electrical power by at least a portion of said solar panel assembly produces a light emission; and
a light sensor disposed along a sightline such that said light emission is visible to said light sensor.

18. The apparatus of claim 17, wherein said light sensor comprises a visible light sensor.

19. The apparatus of claim 17, wherein said light sensor comprises an infrared light sensor.

20. The apparatus of claim 17, wherein said light sensor is disposed proximately to said solar panel assembly.

21. The apparatus of claim 17, wherein said light sensor is disposed distally from said solar panel assembly.

22. A method for identifying a solar panel, comprising:
coupling one or more conductors to a solar panel assembly to convey electrical power from an external power source to said solar panel assembly, wherein conduction of said electrical power by at least a portion of said solar panel assembly produces a light emission; and
disposing a light sensor along a sightline such that said light emission is visible to said light sensor.

23. The method of claim 22, wherein said disposing a light sensor comprises disposing a visible light sensor.

24. The method of claim 22, wherein said disposing a light sensor comprises disposing an infrared light sensor.

25. The method of claim 22, wherein said disposing a light sensor comprises disposing said light sensor proximately to said solar panel assembly.

26. The method of claim 22, wherein said disposing a light sensor comprises disposing said light sensor distally from said solar panel assembly.

27. An apparatus including a system for identifying a solar panel, comprising:
a plurality of solar panels mutually arranged for exposure to ambient light and responsive to respective exposures to said ambient light by providing respective portions of an electrical power;
one or more exposure modulation devices disposed between at least a portion of said plurality of solar panels and a source of at least a portion of said ambient light, and responsive to one or more control signals by modulating at least a portion of said respective exposures to said ambient light; and
detection circuitry coupled to said plurality of solar panels and responsive to said respective portions of an electrical power by detecting one or more modulated portions of said electrical power related to said modulating of said at least a portion of said respective exposures to said ambient light.

28. The apparatus of claim 27, wherein said one or more exposure modulation devices comprises one or more movable members disposed over at least a portion of said plurality of solar panels to provide periodic shading of at least a portion of said plurality of solar panels.

29. The apparatus of claim 27, wherein said one or more exposure modulation devices comprises a plurality of enclosures disposed over respective ones of said portion of said plurality of solar panels, wherein each one of said plurality of enclosures defines an area of one of said plurality of solar panels and includes one or more movable members to selectively reduce exposure of said defined area to said ambient light.

30. The apparatus of claim 27, wherein said one or more exposure modulation devices comprises a plurality of LCD panels disposed over respective ones of said portion of said plurality of solar panels, wherein each one of said plurality of LCD panels overlies an area of one of said plurality of solar panels and is responsive to at least one of said one or more control signals by selectively reducing exposure of said area to said ambient light.

31. A method for identifying a solar panel, comprising:
arranging a plurality of solar panels for exposure to ambient light and responding to respective exposures to said ambient light by providing respective portions of an electrical power;
disposing one or more exposure modulation devices between at least a portion of said plurality of solar panels and a source of at least a portion of said ambient light;
responding, with said one or more exposure modulation devices, to one or more control signals by modulating at least a portion of said respective exposures to said ambient light; and
responding to said respective portions of an electrical power by detecting one or more modulated portions of said electrical power related to said modulating of said at least a portion of said respective exposures to said ambient light.

32. The method of claim 31, wherein said disposing one or more exposure modulation devices between at least a portion of said plurality of solar panels and a source of at least a portion of said ambient light comprises disposing one or more movable members over at least a portion of said plurality of solar panels to provide periodic shading of at least a portion of said plurality of solar panels.

33. The method of claim 31, wherein said disposing one or more exposure modulation devices between at least a portion of said plurality of solar panels and a source of at least a portion of said ambient light comprises disposing a plurality of enclosures over respective ones of said portion of said plurality of solar panels, wherein each one of said plurality of enclosures defines an area of one of said plurality of solar panels and includes one or more movable members to selectively reduce exposure of said defined area to said ambient light.

34. The method of claim 31, wherein said disposing one or more exposure modulation devices between at least a portion of said plurality of solar panels and a source of at least a portion of said ambient light comprises disposing a plurality of LCD panels over respective ones of said portion of said plurality of solar panels, wherein each one of said plurality of LCD panels overlies an area of one of said plurality of solar panels and is responsive to at least one of said one or more control signals by selectively reducing exposure of said area to said ambient light.
